(19) United States
(12) Patent Application Publication
(10) Pub. No.: US 2021/0222826 A1
(43) Pub. Date: Jul. 22, 2021

(54) ADHESIVE HANGER

(71) Applicant: ABDULRAHMAN SALEH AL-HERAIBI, SAFAT (KW)

(72) Inventor: ABDULRAHMAN SALEH AL-HERAIBI, SAFAT (KW)

(21) Appl. No.: 16/747,493

(22) Filed: Jan. 20, 2020

(51) Int. Cl. F16M 13/02; F16B 2/08; A47G 29/00

(52) U.S. Cl. CPC F16M 13/02; A47G 29/00; F16B 2/08

(57) ABSTRACT

The adhesive hanger is a multi-use hanger adapted for supporting a wide variety of different articles. The adhesive hanger includes a flexible strap having opposed first and second surfaces, the strap being elongated and having opposed first and second ends. Each of the first and second ends has an aperture formed therein. A releasable closure is secured to the first surface of the flexible strap for releasably securing the first end to the second end, such that when the first and second ends are secured to one another, the holes respectively formed therein are aligned to form a passage adapted for hanging from an external structure, such as a hook, nail, peg or the like. The releasable closure may be an adhesive, although it should be understood that the adhesive may be replaced by any suitable type of releasable closure.

### BACKGROUND

### 1. Field

The disclosure of the present patent application relates to hangers, and particularly to an adhesive hanger formed from a flexible strap with a releasable closure.

### 2. Description of the Related Art

Multi-use hangers take a wide variety of different forms, including hooks, wires, brackets and the like. Such hangers, however, typically require the use of additional hardware and must be installed using a variety of tools. As an example, a hook is rarely used on its own. Rather, the hook must be mounted on a plate, a backer, a bracket or the like, and this structure must then be fixed to a wall, for example, using screws or the like. It would obviously be desirable to provide a multi-use, multi-purpose hanger that is both easy to use and easy to install.

Thus, an adhesive hanger solving the aforementioned problems is desired.

### SUMMARY

The adhesive hanger is a multi-use hanger adapted for supporting a wide variety of different articles. The adhesive hanger includes a flexible strap having opposed first and second surfaces, the strap being elongated in a longitudinal direction and having longitudinally opposed first and second ends. Each of the first and second ends has an aperture formed therein. A preferably releasable closure is secured to the first surface of the flexible strap for releasably securing the first end to the second end, such that when the first and second ends are secured to one another, the apertures are aligned to form a passage adapted for hanging from an external structure, such as a hook, nail, peg or the like. The releasable closure may be a layer of adhesive, although it should be understood that the layer of adhesive may be replaced by any suitable type of releasable closure, such as, but not limited to, double-sided adhesive tape, magnets, snaps, hook-and-loop fasteners, buttons or the like.

These and other features of the present disclosure will become readily apparent upon further review of the following specification and drawings.

### BRIEF DESCRIPTION OF THE DRAWINGS

FIG. 1 is a perspective view of an adhesive hanger, shown fully elongated.

FIG. 2A is a perspective view of the adhesive hanger of FIG. 1 formed into a loop, shown before closure of the ends of the strap.

FIG. 2B is a perspective view of the adhesive hanger of FIG. 1, shown formed into a loop.

FIG. 3 is an environmental perspective view of the adhesive hanger of FIG. 1, shown with the strap passed through the roller of a roll of toilet paper and secured in a loop for hanging from a hook or peg.

Similar reference characters denote corresponding features consistently throughout the attached drawings.

### DETAILED DESCRIPTION OF THE PREFERRED EMBODIMENTS

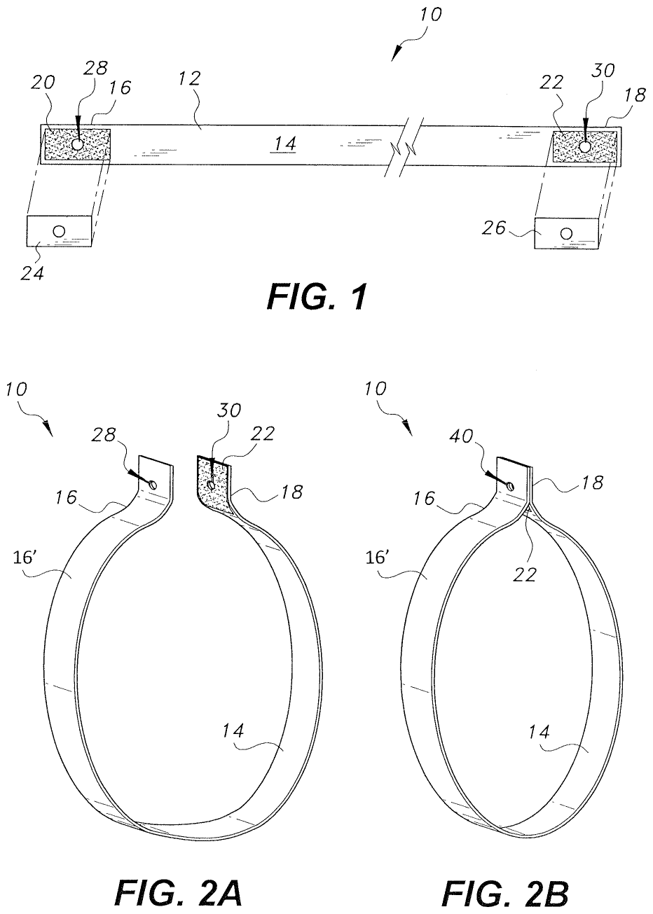

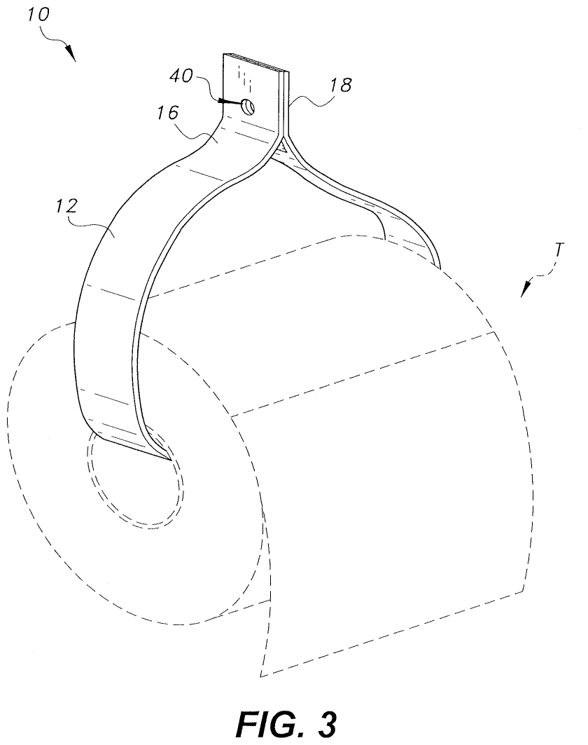

The adhesive hanger 10 is a multi-use hanger adapted for supporting a wide variety of different articles. In FIG. 3, adhesive hanger 10 is shown supporting a conventional roll of toilet paper T. However, it should be understood that the roll of toilet paper T is shown for exemplary and illustrative purposes only, and that the adhesive hanger 10 may be used to hang and/or support any desired article. As shown in FIGS. 1 and 2A, the adhesive hanger 10 includes a flexible strap 12 having opposed first and second surfaces 14, 16, respectively, the strap 12 being elongated in a longitudinal direction and having longitudinally opposed first and second ends 16, 18, respectively. It should be understood that the flexible strap 12 may be made from any suitable type of material that is both flexible and strong enough to support an article for hanging, e.g., nylon or other plastics, rubber, leather, etc.

As shown, each of the first and second ends 16, 18 has an aperture 28, 30 formed therein. A releasable closure, such as adhesive, is disposed on the first surface 14 of the flexible strap 12 for releasably securing the first end 16 to the second end 18. In FIG. 1, the releasable closure is shown taking the form of a first adhesive layer 20 formed on the first surface 14 adjacent the first end 16, and a second adhesive layer 22, also formed on the first surface 14, but adjacent the second end 18. The adhesive is preferably a releasable adhesive, such as pressure sensitive adhesive, self-adhesive, etc., including rubber-based, acrylic-based, silicone-based, or other self-bonding adhesive so that the hanger 10 may be re-used. Release strips 24, 26 may be provided for releasably covering the adhesive layers 20, 22 prior to use. It should be understood that the first and second adhesive layers 20, 22 are shown for exemplary purposes only. Thus, it should be understood that the layers of adhesive may be replaced by any suitable type of releasable closure, such as, but not limited to, double-sided adhesive tape, magnets, snaps, hook-and-loop fasteners, buttons or the like. Further, although two adhesive layers 20, 22 are shown in FIG. 1, it should be understood that only one of ends 16, 18 may be coated with adhesive for releasable attachment to the other non-coated end.

As shown in FIG. 2A, initially, the flexible strap 12 may be formed into a loop such that ends 16, 18 approximate one another. Although FIG. 2A shows the flexible strap 12 in this bent or flexed position without an additional article, such as the exemplary roll of toilet paper T from FIG. 3, it should be understood that the article may be supported or suspended by flexible strap 12 prior to this stage. Alternatively, it should be understood that, depending on the article to be hung, supported or suspended, such initial engagement with the article may not be necessary. In FIG. 2A, the adhesive layers 20, 22 of FIG. 1 are being used and the corresponding release strips 24, 26 have already been removed. In FIG. 2B, the adhesive layers 20, 22 are shown in the process of being adhered together to releasably secure the first end 16 to the second end 18. As shown in FIG. 2A, the apertures 28, 30 are aligned with one another such that, when the first and the second ends 16, 18 are fastened to one another, the aligned apertures form a single passage 40, as shown in FIGS. 2B and 3. In FIG. 3, the first and second ends 16, 18 are fully secured to one another, and the passage 40 is adapted for hanging from an external structure, such as a hook, nail, peg or the like.

It is to be understood that the adhesive hanger is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An adhesive hanger, consisting of:
an elongated, single flexible strap consisting of:
i) opposed first and second surfaces and opposed first and second ends;
ii) each of the first and second ends having a single aperture formed therein, wherein the remainder of the strap is imperforate; and
iii) the first surfaces of each of the first and second ends having releasable adhesive fastener for securing the first and second ends to one another to form a loop adapted for receiving an article to be suspended from the strap, wherein the releasable adhesive fastener is located solely at the first and second ends of the strap and form planar attaching surfaces for the first and second ends, further wherein the apertures in the first and second ends being aligned to form a passage adapted for receiving a support for hanging the strap when the first and second ends of the strap are secured to one another.

2-15. (canceled)
